(19) United States
(12) Patent Application Publication
(10) Pub. No.: US 2014/0028222 A1
(43) Pub. Date: Jan. 30, 2014

(54) SHAPE MEMORY ALLOY DRIVING SYSTEM AND DRIVNG DEVICE

(71) Applicant: HON HAI PRECISION INDUSTRY CO., LTD., New Taipei (TW)

(72) Inventors: Yu-Han Chen, New Taipei (TW); Ho-Kai Liang, New Taipei (TW)

(73) Assignee: HON HAI PRECISION INDUSTRY CO., LTD., New Taipei (TW)

(21) Appl. No.: 13/709,076

(22) Filed: Dec. 10, 2012

(30) Foreign Application Priority Data
Jul. 24, 2012 (TW) 101126556

(51) Int. Cl. H02P 31/00

(52) U.S. Cl. CPC H02P 31/00
USPC 318/117

(57) ABSTRACT

A shape memory alloy (SMA) driving system includes an SMA wire, a power source, a switch element, a temperature sensor, a pulse generator, and a control unit. The power source is electrically connected to one end of the SMA. The switch element includes an input terminal electrically connected to the other end of the SMA, a grounded output terminal, and a control terminal configured for controlling connection and disconnection between the input terminal and the output terminal. The control unit stores a martensite convert temperature and an austenite convert temperature. The control unit compares a temperature detected by the temperature sensor with the martensite convert temperature and the austenite convert temperature. when the detected temperature is lower than the martensite convert temperature and is higher than the austenite convert temperature, the control unit controls the pulse generator to output a higher duty-cycle signal.

### BACKGROUND

1. Technical Field

The present disclosure relates to driving systems, and particularly, to a shape memory alloy (SMA) driving system and a driving device using the SMA driving system.

2. Description of Related Art

SMA driving systems generally include an SMA wire and a power source electrically connected to the SMA wire. The power source outputs a driving current with constant frequency to the SMA wire. As the SMA wire has a constant impedance, when the driving current flows through the SMA wire, the SMA wire will generate a heat according to Joule's law. The SMA wire will generate a deformation under the heat. However, as a crystal structure of the SMA wire will be changed during the process of the deformation, a length variation of the SMA wire is not constant, which results that it is hard to accurately control a scaling length of the SMA wire.

Therefore, it is desirable to provide an SMA driving system and a driving device, which can overcome the limitations described.

### BRIEF DESCRIPTION OF THE DRAWINGS

FIG. 1 is a function view of an SMA driving system in accordance with an exemplary embodiment.

FIG. 2 is an isometric view of a driving device using the SMA driving system of FIG. 1.

### DETAILED DESCRIPTION

Embodiments of the disclosure will be described with reference to the drawings.

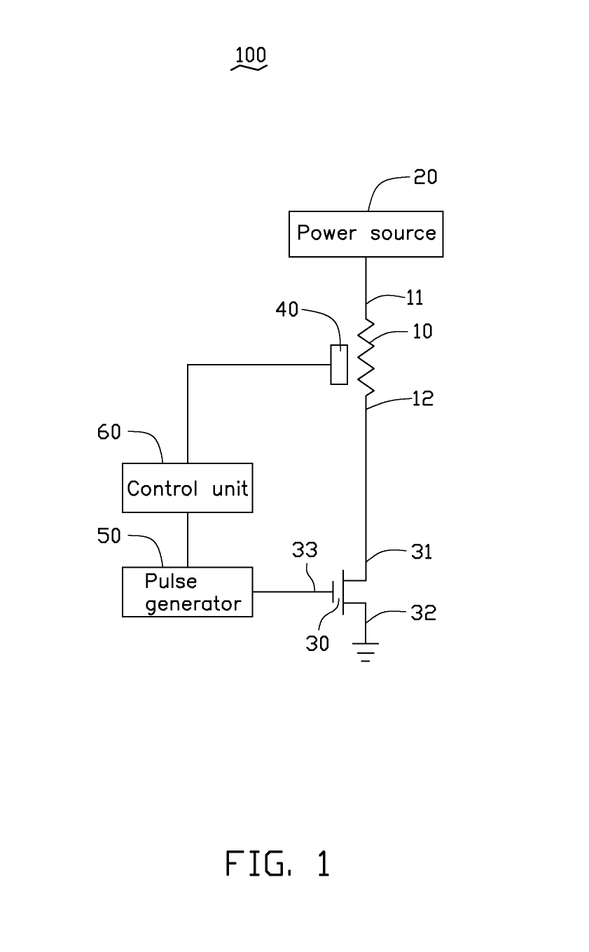

FIG. 1 shows an SMA driving system 100, according to an exemplary embodiment. The SMA driving system 100 includes an SMA wire 10, a power source 20, a switch element 30, a temperature sensor 40, a pulse generator 50, and a control unit 60.

The SMA wire 10 has a martensite convert temperature T0, an austenite convert temperature T1, and a critical temperature T2. The martensite convert temperature T0 is greater than the austenite convert temperature T1, and the critical temperature T2 is greater than the austenite convert temperature T1 and lower than the martensite convert temperature T0. When the temperature of the SMA wire 10 is greater than the critical temperature T2 and is lower than the martensite convert temperature T0, a crystal structure of the SMA wire 10 is changed from the austenite to the martensite. When the temperature of the SMA wire 10 is lower than the critical temperature T2 and is greater than the austenite convert temperature T1, the crystal structure of the SMA wire 10 is changed from the martensite to the austenite. The SMA wire 10 has a higher deformation in the process of crystal converting between the austenite and the martensite; otherwise, the SMA wire 10 has a lower deformation. The SMA wire 10 includes a first end 11 and a second end 12 facing away the first terminal 11.

The power source 20 is electrically connected to the first end 11 of the SMA wire 10, and outputs a driving current to the SMA wire 10. In the embodiment, the power source 20 is a constant current source.

The switch element 30 includes an input terminal 31, an output terminal 32 and a control terminal 33 configured for controlling connection and disconnection between the input terminal 31 and the output terminal 32. The input terminal 31 is connected to the second end 12 of the SMA wire 10. The output terminal 32 is grounded. When a higher level, such as, +5v, is input to the control terminal 33, the input terminal 31 is electrically connected to the output terminal 32. When a lower level, such as, 0v, is input to the control terminal 33, the input terminal 31 is electrically disconnected to the output terminal 32. In the embodiment, the switch element 30 is a metal oxide field-effect transistor, the input terminal 31 is a drain, the output terminal 32 is a source, and the control terminal 33 is a gate.

The temperature sensor 40 is configured for detecting a temperature of the SMA wire 10. The temperature sensor 40 is electrically connected to the control unit 60, and outputs the temperature of the SMA wire 10 to the control unit 60.

The pulse generator 50 is electrically connected to the control terminal 33 of the switch element 30. The pulse generator 40 outputs a higher duty-cycle signal and a lower duty-cycle signal to the control terminal 33. The pulse width of the higher duty-cycle signal is equal to the pulse width of the lower duty-cycle signal, and the pulse frequency of the higher duty-cycle signal is greater than the pulse frequency of the lower duty-cycle signal. The phase of the higher duty-cycle signal and the lower duty-cycle signal is about +5v.

The control unit 60 per-stores the martensite convert temperature T0 and the austenite convert temperature T1 therein. The control unit 60 is electrically connected to the pulse generator 50. When the temperature detected by the temperature sensor 40 is greater than the austenite convert temperature T1 and is lower than the martensite convert temperature T0, the control unit 60 outputs a control signal to the pulse generator 50.

In use, the power source 20 outputs the constant driving current to the SMA wire 10. The SMA wire 10 generates a heat according to Joule's law. The temperature sensor 40 detects the temperature of the SMA wire 10, and outputs the temperature to the control unit 60. The control unit 60 compares the temperature of the SMA wire 10 with the austenite convert temperature Ti and the martensite convert temperature T0.

When the detected temperature is greater than the austenite convert temperature T1 and lower than the martensite convert temperature T0, the control unit 60 outputs a control signal to the pulse generator 50. The pulse generator 50 outputs a higher duty-cycle signal to the control terminal 33, therefore the frequency of the driving current flowing through the SMA wire 10 is higher. When the detected temperature is lower than the austenite convert temperature T1 or is higher than the martensite convert temperature T0, the control unit 60 does not output the control signal. The pulse generator 50 outputs a lower duty-cycle signal to the control terminal 33, therefore the frequency of the driving current flowing through the SMA wire 10 is lower.

When the SMA wire 10 is in the process of the higher deformation, the frequency of the driving current flowing through the SMA wire 10 is higher. When the SMA wire 10 is in the process of the lower deformation, the frequency of the driving current flowing through the SMA wire 10 is lower. Therefore, the scaling length of the SMA can be accurately controlled.

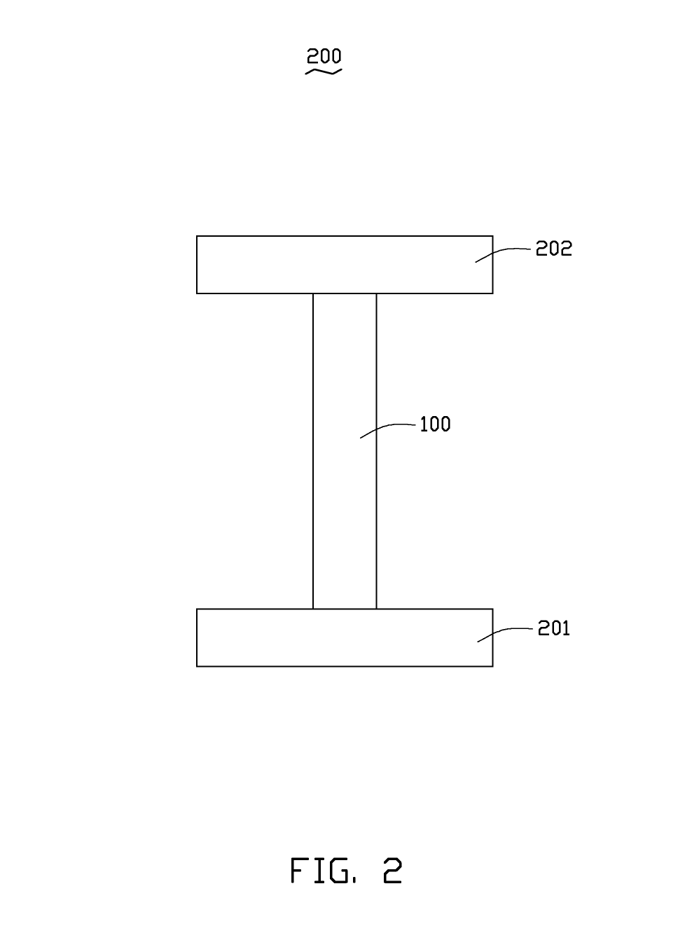

Referring to FIG. 2, a driving device 200, according to an exemplary embodiment, includes the SMA driving system 100, a fixing portion 201, and a moving portion 202. The first and second ends 11, 12 of the SMA wire 10 are connected to the fixing portion 201 and the moving portion 202. The SMA wire 10 drives the moving portion 202 to move corresponding to the fixing portion 201.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A shape memory alloy (SMA) driving system, comprising:
an SMA wire;
a power source electrically connected to one end of the SMA;
a switch element comprising an input terminal, an output terminal, and a control terminal, the input terminal electrically connected to the other end of the SMA, the output terminal being grounded, the control terminal configured for controlling connection and disconnection between the input terminal and the output terminal;
a temperature sensor configured for detecting a temperature of the SMA;
a pulse generator electrically connected to the control terminal, the pulse generator selectively outputting a higher duty-cycle signal or a lower duty-cycle signal to the control terminal, wherein the pulse frequency of the higher duty-cycle signal is greater than the pulse frequency of the lower duty-cycle signal; and
a control unit electrically connected to the temperature sensor and the pulse generator, the control unit storing a martensite convert temperature and an austenite convert temperature, the control unit comparing the temperature detected by the temperature sensor with the martensite convert temperature and the austenite convert temperature, wherein when the detected temperature is lower than the martensite convert temperature and is higher than the austenite convert temperature, the control unit controls the pulse generator to output the higher duty-cycle signal.

2. The SMA driving system of claim 1, wherein the martensite convert temperature is greater than the austenite convert temperature.

3. The SMA driving system of claim 1, wherein when the detected temperature is higher than the martensite convert temperature or is lower than the austenite convert temperature, the control unit controls the pulse generator to output the lower duty-cycle signal.

4. The SMA driving system of claim 1, wherein the SMA wire has a critical temperature, the critical temperature is greater than the austenite convert temperature and is lower than the martensite convert temperature, when the temperature of the SMA is greater than the critical temperature and is lower than the martensite convert temperature, a crystal structure of the SMA wire is changed from the austenite to the martensite.

5. The SMA driving system of claim 4, wherein when the temperature of the SMA wire is lower than the critical temperature and is greater than the austenite convert temperature, the crystal structure of the SMA wire is changed from the martensite to the austenite.

6. The SMA driving system of claim 5, wherein the SMA has a higher deformation in the process of crystal converting between the austenite and the martensite.

7. The SMA driving system of claim 1, wherein the power source is a constant current source.

8. A driving device, comprising:
a fixing portion;
a moving portion; and
an SMA driving system, comprising:
an SMA wire connected between the fixing portion and the moving portion;
a power source electrically connected to one end of the SMA;
a switch element comprising an input terminal, an output terminal, and a control terminal, the input terminal electrically connected to the other end of the SMA, the output terminal being grounded, and the control terminal configured for controlling connection and disconnection between the input terminal and the output terminal;
a temperature sensor configured for detecting a temperature of the SMA;
a pulse generator electrically connected to the control terminal, the pulse generator selectively outputting a higher duty-cycle signal or a lower duty-cycle signal to the control terminal, wherein the pulse frequency of the higher duty-cycle signal is greater than the pulse frequency of the lower duty-cycle signal; and
a control unit electrically connected to the temperature sensor and the pulse generator, the control unit storing a martensite convert temperature and an austenite convert temperature, the control unit comparing the temperature detected by the temperature sensor with the martensite convert temperature and the austenite convert temperature, wherein when the detected temperature is lower than the martensite convert temperature and is higher than the austenite convert temperature, the control unit controls the pulse generator to output the higher duty-cycle signal.
